(19) United States
(12) Patent Application Publication
(10) Pub. No.: US 2025/0370191 A1
(43) Pub. Date: Dec. 4, 2025

(54) POLYMER OPTICAL WAVEGUIDE AND OPTICAL WAVEGUIDE COMPONENT

(71) Applicant: SHINKO ELECTRIC INDUSTRIES CO., LTD., Nagano (JP)

(72) Inventor: Kenji YANAGISAWA, Nagano (JP)

(21) Appl. No.: 19/215,927

(22) Filed: May 22, 2025

(30) Foreign Application Priority Data
May 31, 2024 (JP) 2024-088676

(51) Int. Cl. G02B 6/36

(52) U.S. Cl. CPC G02B 6/368

(57) ABSTRACT

A polymer optical waveguide includes a plurality of cores arranged on an imaginary plane, a cladding disposed around the plurality of the cores, and a groove formed in the cladding and positioned between two cores adjacent each other among the plurality of cores, wherein the groove has a first wall surface extending along the two cores, and the first wall surface is inclined with respect to a normal direction of the imaginary plane.

### CROSS-REFERENCE TO RELATED APPLICATIONS

The present application is based on and claims priority to Japanese Patent Application No. 2024-088676 filed on May 31, 2024, with the Japanese Patent Office, the entire contents of which are incorporated herein by reference.

### FIELD

The disclosures herein relate to polymer optical waveguides and optical waveguide components.

### BACKGROUND

In a conventional polymer waveguide including a plurality of cores, the pitch of the cores may differ between the input ends and the output ends of the cores. In such a configuration, the cores have a curved shape.

When cores have a curved shape, there is a possibility that crosstalk occurs due to leakage of light propagating through the cores.

The present disclosure provides a polymer optical waveguide and an optical waveguide component capable of reducing crosstalk between cores.

### PRIOR ART DOCUMENTS

### Patent Document

[Patent document 1] Japanese Patent Publication No. 2003-014964
[Patent document 2] International Publication No. 2019/111401

### SUMMARY

According to an aspect of the embodiment, a polymer optical waveguide includes a plurality of cores arranged on an imaginary plane, a cladding disposed around the plurality of the cores, and a groove formed in the cladding and positioned between two cores adjacent each other among the plurality of cores, wherein the groove has a first wall surface b extending along the two cores, and the first wall surface is inclined with respect to a normal direction of the imaginary plane.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a top view illustrating an example of a polymer optical waveguide according to a first embodiment;

FIGS. 2A and 2B are cross-sectional views illustrating the example of the polymer optical waveguide according to the first embodiment;

FIGS. 3A and 3B are cross-sectional views illustrating an example of a method of making the polymer optical waveguide according to the first embodiment;

FIG. 4 is a cross-sectional view illustrating an example of a polymer optical waveguide according to a variation of the first embodiment;

FIG. 5 is a top view illustrating an example of an optical waveguide component according to a second embodiment; and

FIG. 6 is a cross-sectional view illustrating the example of the optical waveguide component according to the second embodiment.

### DESCRIPTION OF EMBODIMENTS

In the following, embodiments of the present disclosure will be described with reference to the accompanying drawings. In the present specification and the drawings, components having substantially the same functional configuration may be denoted by the same reference numerals, and a duplicate description may be omitted.

### First Embodiment

A first embodiment is described below. The first embodiment is directed to a polymer optical waveguide.

### [Structure of Polymer Optical Waveguide]

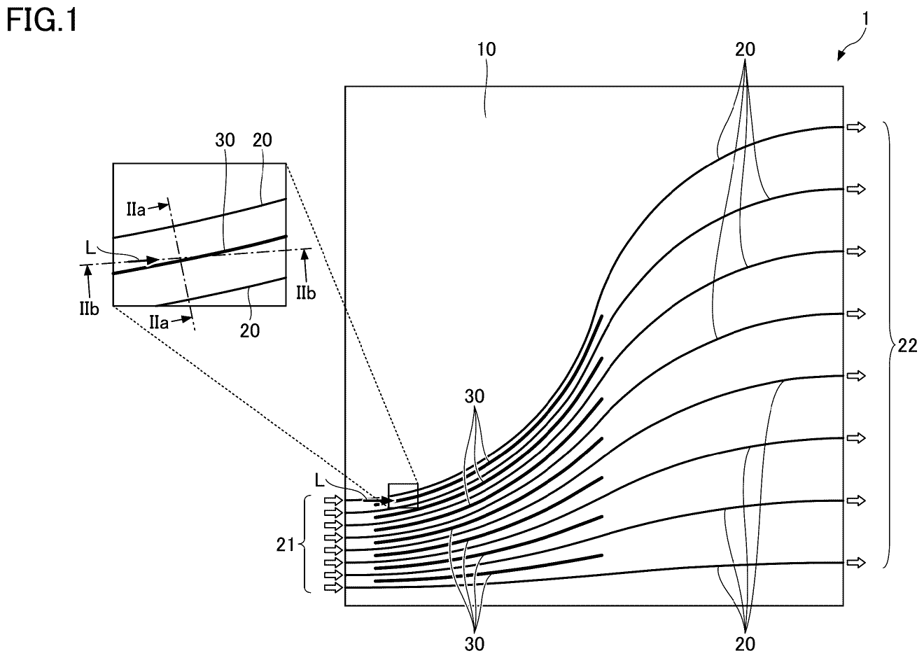

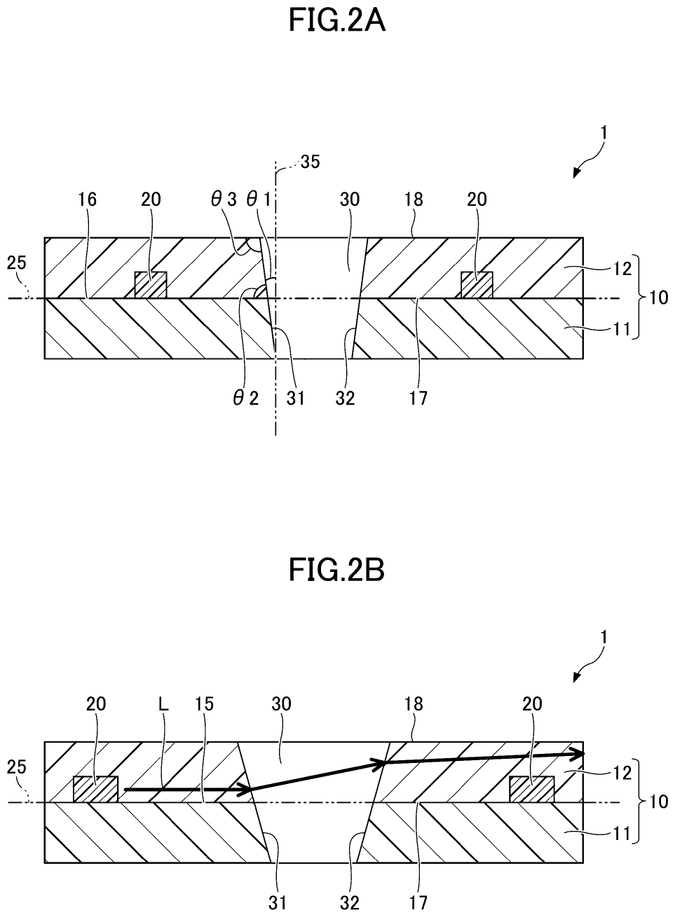

The structure of a polymer optical waveguide according to the first embodiment will now be described. FIG. 1 is a top view illustrating an example of the polymer optical waveguide according to the first embodiment. FIGS. 2A and 2B are cross-sectional views illustrating the example of the polymer optical waveguide according to the first embodiment. FIG. 2A corresponds to a cross-sectional view along the line IIa-IIa in FIG. 1, and FIG. 2B corresponds to a cross-sectional view along the line IIb-IIb in FIG. 1.

As illustrated in FIGS. 1 and FIGS. 2A and 2B, the polymer optical waveguide 1 according to the first embodiment includes a cladding 10 and a plurality of cores 20. The cladding 10 is disposed around a plurality of cores 20. The cladding 10 includes a first cladding layer 11 and a second cladding layer 12. The first cladding layer 11 and the second cladding layer 12 are laminated to each other. The first cladding layer 11 has a first main surface 16. The second cladding layer 12 has a second main surface 17 in contact with the first main surface 16 and a third main surface 18 opposite the second main surface 17.

In this embodiment, for convenience, with the first cladding layer 11 as a reference, the second cladding layer 12 side is defined as an upper side or one side, and the opposite side is referred to as a lower side or an opposite side. The surface of each component on the upper side is referred to as one surface or an upper surface, and the surface on the lower side is referred to as an opposite surface or a lower surface. It may be noted, however, the polymer optical waveguide 1 may be positioned upside down when used, or may be arranged at any angle.

The plurality of cores 20 are arranged on an imaginary plane 25. The imaginary plane 25 includes the first main surface 16. The second cladding layer 12 is disposed on the first main surface 16 and covers the plurality of cores 20. The plurality of cores 20 are sandwiched between the first cladding layer 11 and the second cladding layer 12. Each of the cores has an input end 21 and an output end 22. The cores are configured, for example, such that the input ends 21 are arranged at equal intervals of 50 μm, and the output ends 22 are arranged at equal intervals of 250 μm. In plan view perpendicular to the imaginary plane 25, each of the cores 20 has a curved shape having one inflection point between the input end 21 and the output end 22. In plan view, the curvatures of the cores 20 vary, but have the same curvature direction.

The material of the first cladding layer 11 is an organic resin such as epoxy resin or polyimide resin. The thickness of the first cladding layer 11 is, for example, about 10 μm to 30 μm.

The material of the cores 20 is an organic resin such as epoxy resin or polyimide resin. For example, the cross-sectional shape perpendicular to the direction of the core 20 is rectangular. In order to obtain a single-mode optical waveguide, the cores may each have a small cross-sectional area. For example, the width of each core 20 is 5 μm to 10 μm, and the height is 5 μm to 10 μm.

The material of the second cladding layer 12 is an organic resin such as epoxy resin or polyimide resin. The thickness of the second cladding layer 12 is, for example, about 10 μm to 30 μm.

In the polymer optical waveguide 1, the refractive indexes of the cores 20 are higher than those of the first cladding layer 11 and the second cladding layer 12.

The cladding 10 has grooves 30 each formed between two adjacent cores 20 among the plurality of cores 20. The grooves 30 each penetrate the second cladding layer 12 and the first cladding layer 11. For example, there is air in the grooves 30. The width of each groove 30 is, for example, about 10 μm to 30 μm. Each groove 30 extends, for example, along the portion of each of the two adjacent cores 20 between the input end 21 and the inflection point. Each groove has a wall surface 31 and a wall surface 32 extending along the two adjacent cores 20. The wall surface 31 and the wall surface 32 face each other. Each groove 30 has a tapered cross-sectional shape. The wall surfaces 31 and 32 are inclined with respect to the normal direction 35 of the imaginary plane 25. For example, the wall surfaces 31 and 32 are inclined in opposite directions with respect to the normal direction 35. The angle θ1 formed between the normal direction 35 and the wall surface 31 is about 7 degrees. The inner angle θ2 between the wall surface 31 and the second main surface 17 of the second cladding layer 12 is acute, and the inner angle θ3 between the wall surface 31 and the third main surface 18 of the second cladding layer 12 is obtuse. The angle formed between the normal direction 35 and the wall surface 32 is about 7 degrees. The inner angle between the wall surface 32 and the second main surface 17 of the second cladding layer 12 is acute, and the inner angle between the wall surface 32 and the third main surface 18 of the second cladding layer 12 is obtuse. The wall surface 31 is an example of a first wall surface, and the wall surface 32 is an example of a second wall surface.

### [Method of Making Polymer Optical Waveguide]

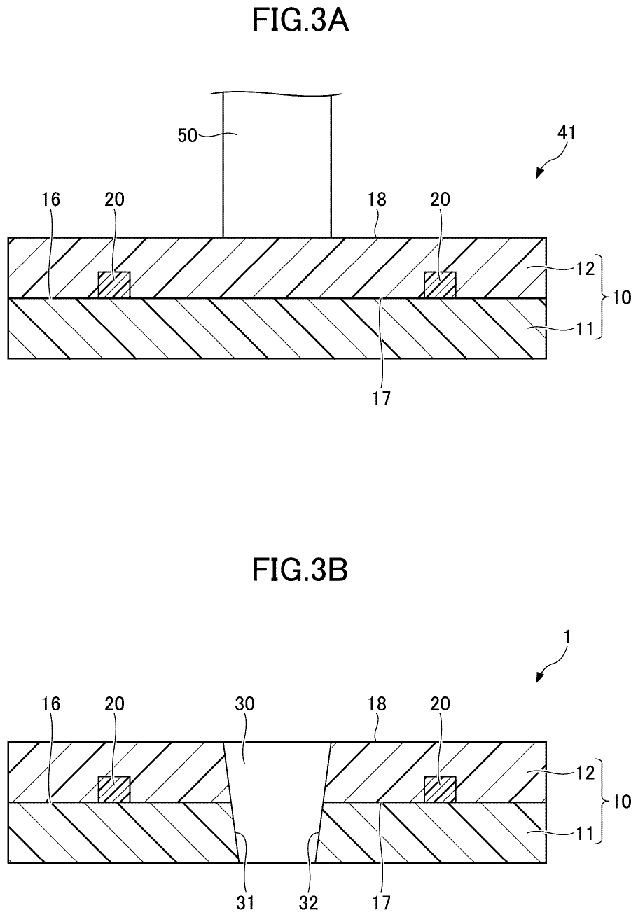

A method of making the polymer optical waveguide 1 is described below. FIGS. 3A and 3B are cross-sectional views illustrating an example of a method of making a polymer optical waveguide according to the first embodiment.

First, as illustrated in FIG. 3A, an intermediate structure 41 having the cladding 10 and the plurality of cores 20 is formed. Specifically, the plurality of cores 20 are formed on the first cladding layer 11, and the second cladding layer 12 is formed on the first cladding layer 11 and the plurality of cores 20. In the intermediate structure 41, the cladding 10 is disposed around the plurality of cores 20.

Next, as in the manner illustrated in FIG. 3B, the plurality of grooves 30 are formed in the intermediate structure 41. In forming the grooves 30, a laser beam 50 is directed to the third main surface 18 of the second cladding layer 12. The laser beam 50 may be, for example, an excimer laser beam. Irradiation by the laser beam 50 results in the formation of each groove 30 having the wall surface 31 and the wall surface 32. When an excimer laser beam is used as the laser beam 50 and oriented perpendicular to the third main surface 18, the angle between the normal direction 35 and the wall surface 31 and the angle between the normal direction 35 and the wall surface 32 are both about 7°.

In this manner, the polymer optical waveguide 1 according to the first embodiment is effectively manufactured.

In the polymer optical waveguide 1, light input into the input ends 21 propagate through the b cores 20 and is output from the output ends 22. Since the cores 20 are curved, the propagation of light through the cores 20 causes light to leak along the tangents of the cores 20. As a result, leaked light L as illustrated in FIGS. 1 and 2B may be observed. When the leaked light L reaches adjacent cores 20, crosstalk occurs. Crosstalk may cause deterioration in signal quality and transmission errors. FIG. 2A illustrates a cross section perpendicular to the longitudinal direction of the illustrated groove 30, and FIG. 2B illustrates a cross section parallel to the traveling direction of the leaked light L.

In this embodiment, each groove 30 having the wall surface 31 and the wall surface 32 is formed in the cladding 10, and the wall surface 31 and the wall surface 32 are inclined with respect to the normal direction 35. With this arrangement, the leaked light L, which first travels in the cladding parallel to the imaginary plane 25, refracts at the wall surface 31 so as to be directed away from the imaginary plane 25, followed by traveling inside the groove 30. The leaked light L traveling inside the groove 30 is refracted at the wall surface 32 to enter the cladding 10, but does not reach the core 20. According to the polymer optical waveguide 1, thus, crosstalk between the cores 20 caused by the leaked light L is effectively reduced.

It may be noted that the groove 30 need not be formed throughout the entire length of the area between two adjacent cores 20. For example, the groove is preferably formed at a position where leaked light L is likely to occur and at a position where two adjacent cores 20 are relatively close to each other. That is, the groove 30 is preferably formed in the proximity of a place where the curvature of the cores 20 is large and a place where the distance between the two adjacent cores 20 is small.

### Variation of First Embodiment

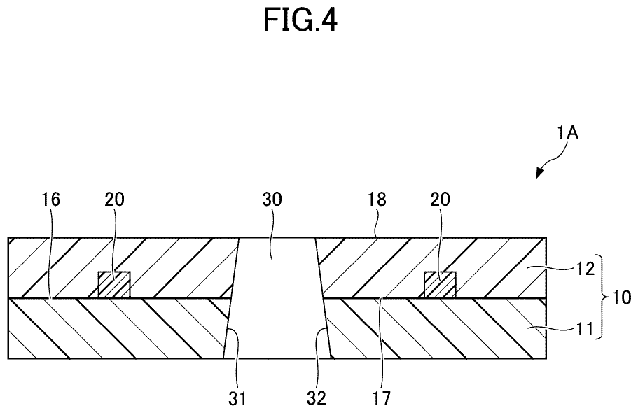

The shapes of the grooves 30 are not limited to those described above. FIG. 4 is a cross-sectional view illustrating a polymer waveguide according to a variation of the first embodiment.

In a polymer optical waveguide 1A according to the variation of the first embodiment, as illustrated in FIG. 4, the grooves 30 are each formed in an inverted tapered shape. That is, the internal angle between the wall surface 31 and the second main surface 17 of the second cladding layer 12 is obtuse, and the internal angle between the wall surface 31 and the third main surface 18 of the second cladding layer 12 is acute. The internal angle between the wall surface 32 and the second main surface 17 of the second cladding layer 12 is obtuse, and the internal angle between the wall surface 32 and the third main surface 18 of the second cladding layer 12 is acute.

In the polymer optical waveguide 1A also, crosstalk between the cores 20 is effectively reduced.

The angle formed between the wall surface 31 and the normal direction 35 does not have to be equal to the angle formed between the wall surface 32 and the normal direction 35. That is, the angle between the wall surface 31 and the normal direction may be larger than the angle between the wall surface 32 and the normal direction 35, or smaller than the angle between the wall surface 32 and the normal direction 35.

The angle between the normal direction 35 and the wall surface 31 and the angle between the normal direction 35 and the wall surface 32 are not limited. In order to reliably prevent the leaked light L generated in one core 20 from reaching another core 20, the angle between the normal direction 35 and the wall surface 31 and the angle between the normal direction 35 and the wall surface 32 are preferably 3 degrees or more. As was previously described, when the excimer laser beam is used as the laser beam 50 and is directed perpendicularly to the third main surface 18, the angle between the normal direction 35 and the wall surface 31 and the angle between the normal direction 35 and the wall surface 32 are both about 7 degrees. Considering a slight deviation from 7 degrees, the angle between the normal direction 35 and the wall surface 31 and the angle between the normal direction 35 and the wall surface 32 may be within the range of 4 degrees to 10 degrees, 5 degrees to 9 degrees, or 6 degrees to 8 degrees.

### Second Embodiment

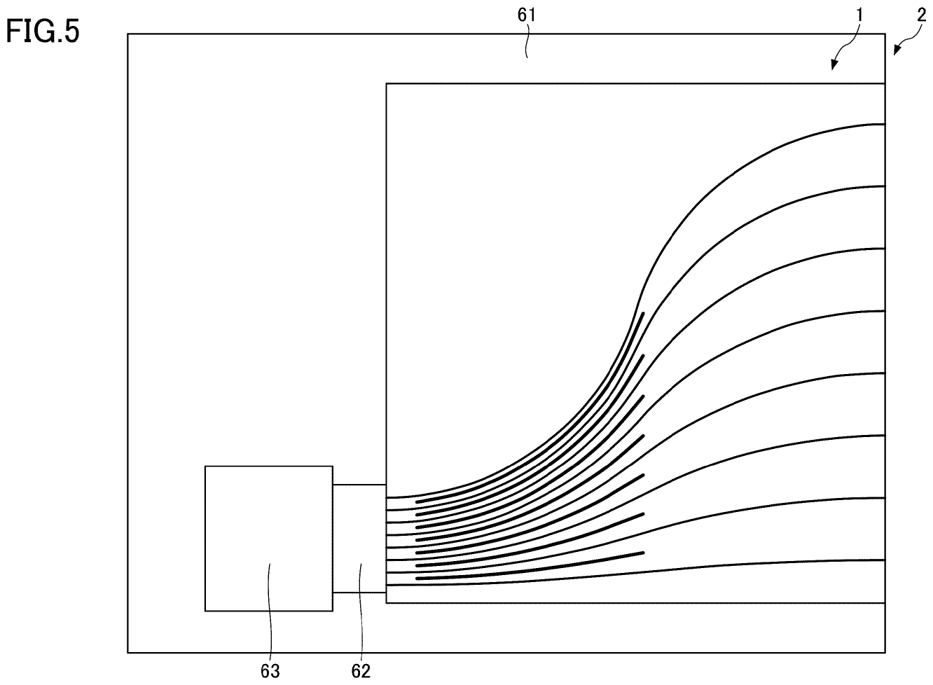

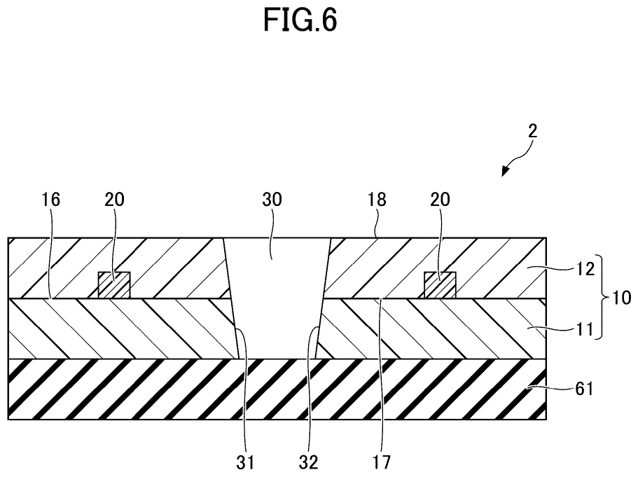

The second embodiment is described below. The second embodiment relates to an optical waveguide component having a polymer optical waveguide according to the first embodiment. FIG. 5 is a top view illustrating an example of the optical waveguide component according to the second embodiment. FIG. 6 is a cross-sectional view illustrating the example of the optical waveguide component according to the second embodiment.

As illustrated in FIGS. 5 and 6, an optical waveguide component 2 according to the second embodiment includes a substrate 61, the polymer optical waveguide 1 according to the first embodiment, an optical semiconductor device 62, and a control device 63. The substrate 61 is, for example, a printed circuit board. The polymer optical waveguide 1 is disposed on the substrate 61. The optical semiconductor device 62 and the control device 63 are mounted on the substrate 61. The optical semiconductor device 62 is configured using silicon photonics and includes, for example, a laser diode. The optical semiconductor device 62 is optically coupled to the polymer optical waveguide 1. The control device 63 controls the optical semiconductor device 62.

The provision of the polymer optical waveguide 1 in the optical waveguide component 2 according to the second embodiment effectively reduces crosstalk between the cores 20 caused by leaked light.

According to the present disclosure, crosstalk between the cores can be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A polymer optical waveguide comprising:
a plurality of cores arranged on an imaginary plane;
a cladding disposed around the plurality of the cores; and
a groove formed in the cladding and positioned between two cores adjacent each other among the plurality of cores,
wherein the groove has a first wall surface extending along the two cores, and the first wall surface is inclined with respect to a normal direction of the imaginary plane.

2. The polymer optical waveguide according to claim 1, wherein the groove has a second wall surface extending along the two cores and facing the first wall surface, and the second wall surface is inclined with respect to the normal direction.

3. The polymer optical waveguide according to claim 2, wherein the first wall surface and the second wall surface are inclined in opposite directions with respect to the normal direction.

4. The polymer optical waveguide according to claim 2, wherein an angle formed between the normal direction and the second wall surface is greater than or equal to 3 degrees.

5. The polymer optical waveguide according to claim 1, wherein an angle formed between the normal direction and the first wall surface is greater than or equal to 3 degrees.

6. The polymer optical waveguide according to claim 1, wherein the cladding includes:
a first cladding layer having a first main surface; and
a second cladding layer disposed on the first main surface,
wherein the imaginary plane includes the first main surface, and the plurality of cores are sandwiched between the first cladding layer and the second cladding layer.

7. The polymer optical waveguide according to claim 6, wherein the groove penetrates the second cladding layer, and the second cladding layer includes:
a second main surface in contact with the first main surface; and
a third main surface opposite the second main surface, and
wherein an internal angle between the first wall surface and the second main surface is acute, and an internal angle between the first wall surface and the third main surface is obtuse.

8. An optical waveguide component comprising
a substrate; and
the polymer optical waveguide of claim 1 disposed on the substrate.
